(19) United States
(12) Patent Application Publication
(10) Pub. No.: US 2010/0135549 A1
(43) Pub. Date: Jun. 3, 2010

(54) VERTEBRAL FRACTURE PREDICTION

(75) Inventors: Paola Pettersen, Vallo (DK); Marleen De Bruijne, Copenhagen (DK); Claus Christiansen, Morcote (CH); László B. Tankó, Ballerup (DK)

Correspondence Address: EDWARDS ANGELL PALMER & DODGE LLP, P.O. BOX 55874, BOSTON, MA, 02205, US

(73) Assignee: Nordic Bioscience Imaging A/S, Herlev (DK)

(21) Appl. No.: 12/450,421

(22) PCT Filed: Mar. 27, 2008
(86) PCT No.: PCT/EP2008/053664

§ 371 Date: Jan. 11, 2010

(30) Foreign Application Priority Data
Mar. 27, 2007 (GB) 0705881.1

(51) Int. Cl. G06K 9/00; G06F 19/00

(52) U.S. Cl. 382/128; 702/19

(57) ABSTRACT

A method of processing data derived from an image of at least part of a spine is provided for estimating the risk of a future fracture in vertebrae of the spine. Position data relating to at least four neighbouring vertebrae of the spine is processed. The curvature of the spine at least two of the neighbouring vertebrae is calculated. The different curvature values are computed to obtain a value representative of the degree of irregularity in curvature of the spine and using the degree of irregularity, an estimate of the risk of a future fracture in vertebrae of the spine is provided. A higher degree of irregularity indicates a higher risk of future fracture.

The present invention relates to a method of estimating the risk of a future fracture in vertebrae of a spine.

Osteoporosis and related complications, such as fragility fracture, remain the centre of major healthcare problems worldwide.

Vertebral fractures are the most common type of osteoporotic fractures contributing with approximately 750,000 cases per year. Presence of vertebral fractures has been associated with acute and chronic pain, impaired life quality, as well as with shortened life expectancy. There is, therefore, a continuing interest in identifying independent predictors of vertebral fractures that could facilitate the recognition of high-risk patients, who would benefit the most from early prevention.

It has been found that the aetiology of a vertebral fracture is multi-factorial and cannot be solely explained by the level and distribution of bone mineral density (BMD). Structural failure only occurs when the load exposing the vertebra exceeds its load-bearing capacity. In the past years, there has been increasing attention focused on the better understanding of how the size and shape of adjacent vertebrae (that considerably influence the load distribution in a spine) influence fracture risk. It has also been noticed (in this context) that the presence of fractures in the spine exerts a strong inclination to sustain subsequent fractures, independently of BMD and other risk fractures.

Since physiological curvatures of the human spine are meant to increase stability in the upright posture by reducing bending moments and energy expenditure during walking, the present inventors considered whether alterations in the degree of lordosis and/or the irregularities of vertebral alignment have direct implications for fracture development. Although the implications of hyperkyphotic posture for the mechanical load of the vertebral spine and risk of future fractures have been proposed in the past, the implications of lordosis and vertebral alignment for fractures of the lumbar vertebrae—the most frequent sites of fragility fractures in postmenopausal women—have not yet been investigated.

The physiological curvatures of the spine are produced by subtle differences in the anterior and posterior vertebral heights within a vertebra and between adjacent vertebrae. Based on this knowledge Zebaze et al recently outlined an approach to the estimation of the regularity/irregularity of the spine based on examination of the ratio of the anterior/posterior height ratios of adjacent vertebrae. They have shown that adjacent vertebrae in any part of the spine are aligned to form a structure defined by two curves: one formed by the anterior, the other by the posterior vertebral heights. If the degree of bending at two adjacent vertebrae is the same the centre and the radius of the curvature curves will be the same, therefore there is regularity. In contrast, when the bending of the curves at a given level changes abruptly, this indicates the presence of irregularity.

The introduced measure of irregularity is the degree to which adjacent vertebrae fail to form unity. It was also shown in this study that this measure of irregularity showed significant correlation with different correlates of spinal fragility (e.g. age, height loss, BMD, and number of fractures), suggesting that irregularities are linked to different indicators of osteoporosis.

In the studies above, however, the issue of whether irregularities of vertebral alignment can be used to alert us to progressive vertebral deformations and to predict and to quantify a degree of risk of ultimate fracture, has not been addressed systematically.

We have now found that a high level of irregularity of spinal curvature in a non-fractured spine is predictive of future fracture risk.

According to the first aspect of the present invention, there is provided a method of estimating the risk of a future fracture in vertebrae of a spine by processing data derived from an image of at least part of a spine, comprising the steps of processing position data relating to at least four neighbouring vertebrae of the spine, calculating the curvature of the spine at least two of said neighbouring vertebrae, computing the different curvature values to obtain a value representative of the degree of irregularity in curvature of the spine, and using the degree of irregularity in curvature of the spine to provide an estimate of the risk of a future fracture in vertebrae of the spine, a higher degree of irregularity indicating a higher risk of future fracture.

Position data, as referred to in this specification, includes information about the absolute location of a specific feature and the location of a specific feature on a vertebra relative to another feature located on the same vertebra, or the same specific feature located on an adjacent vertebra.

Preferably, the spine which is the subject of the estimate of risk is non-fractured at the time of estimation.

Preferably, the computed degree of irregularity is compared with previously established similarly computed values of spinal curvature irregularity representing respectively a lower risk and a higher risk of future fracture in order to judge or determine the risk associated with the computed value. Said previously computed values are preferably based on measurements made on a population of individuals who did not go on to develop spinal fractures within a significant period (e.g. 7-15 years) and on measurements made on a population of individuals who did go on to develop spinal fractures within said significant period. Preferably, the population is chosen to match the subject in terms of body mass index (BMI), alcohol and milk consumption, ever use of hormone replacement treatment, spine BMD (L1-L4), smoking habit, and self-reported physical exercise.

Preferably, the method further comprises processing position data derived from a later image of the same part of said spine and relating to the same at least four neighbouring vertebrae of the spine for which data was used previously, calculating the curvature of the spine at the same at least two of said neighbouring vertebrae for which curvature was calculated previously, computing the different new curvature values to obtain a new value representative of the degree of irregularity in curvature of the spine, and comparing the new value representative of the degree of irregularity in curvature of the spine with the value obtained earlier in time.

By way of this method irregularity in curvature of the spine can be monitored and can therefore be used to ascertain an increased likelihood of vertebral fracture.

In a preferred embodiment, the method further comprises processing position data relating to n neighbouring vertebrae in a region of interest of the spine calculating the curvature of the spine at n−2 of the n neighbouring vertebrae, and using the curvature values at said n−2 vertebrae, calculating the mean curvature of the region of interest of the spine.

Preferably, the step of deriving a value representative of the irregularity of curvature of the spine comprises calculating a value representing an average of the absolute differences between individual curvatures at 2 to n−2 vertebrae in the region of interest of the spine and the mean curvature of the region of interest of the spine.

Alternatively, and/or additionally, the step of calculating the curvature at the individual vertebrae comprises:

identifying a corresponding feature in three adjacent vertebrae of said at least four neighbouring vertebrae; and

using said corresponding features to calculate curvature of the spine at the middle vertebra of said three adjacent vertebrae.

The feature may be any point found in each of the vertebrae from which a curve may be defined.

In a preferred embodiment, the step of identifying a corresponding feature in each of the three adjacent vertebrae comprises locating the centre point of each vertebra, the method further comprising using the centre points of said three adjacent vertebrae to define part of a circle, and calculating the radius of said circle, wherein a value representative of curvature is calculated as the inverse of the radius.

Alternatively, the step of identifying a corresponding feature in each of the three adjacent vertebrae may comprise locating the corner points of each vertebra, the method further comprising using said corner points of said three adjacent vertebrae to define part of a circle, and calculating the radius of said circle, wherein a value representative of curvature is calculated as the inverse of the radius.

In an alternative embodiment, the step of calculating the curvature at the individual vertebrae may comprise calculating the angle of orientation of one vertebra relative to its two adjacent vertebrae.

The method may include the step of taking an image of a region of interest of a spine from which the irregularity measure is calculable.

The imaged region of interest preferably contains more than four vertebrae, e.g. five or six vertebrae. In a preferred embodiment, the region of interest contains six neighbouring vertebrae and curvature values are calculated for the four middle vertebrae.

The method may include initiating a course of treatment to prevent or to reduce osteoporosis of the spine when the measured irregularity is above a certain level.

The method may additionally or alternatively be used at the entry point for a clinical study. For example, the method may be used to reduce the number of people required for a study relating to osteoporosis by identifying those people at risk of future vertebral fractures.

The method may also be used to mark the endpoint for participants of a clinical study. For example, the method may be used to identify participants in a clinical trial who are at increased risk of suffering a vertebral fracture. Thus, a person who develops an increased risk of fracture may be exempted from a study prior to suffering a vertebral fracture.

According to a second aspect of the present invention, there is provided an instruction set comprising instructions for processing position data relating to at least four neighbouring vertebrae of the spine, calculating the curvature of the spine at least two of said neighbouring vertebrae, computing the different curvature values to obtain a value representative of the degree of irregularity in curvature of the spine, and using the degree of irregularity in curvature of the spine to provide an estimate of the risk of a future fracture in vertebrae of the spine, a higher degree of irregularity indicating a higher risk of future fracture.

According to a third aspect of the present invention, there is provided a data storage apparatus for estimating the risk of a future fracture in vertebrae of a spine by processing an image of part of a spine, the data storage apparatus comprising a processor arranged to process position data relating to at least four neighbouring vertebrae of the spine, calculate the curvature of the spine at least two of said neighbouring vertebrae, compute the different curvature values to obtain a value representative of the degree of irregularity in curvature of the spine, and using the degree of irregularity in curvature of the spine to provide an estimate of the risk of a future fracture in vertebrae of the spine, a higher degree of irregularity indicating a higher risk of future fracture.

The invention will be further described and illustrated with reference to specific embodiments thereof with reference being made to the accompanying drawings, in which:

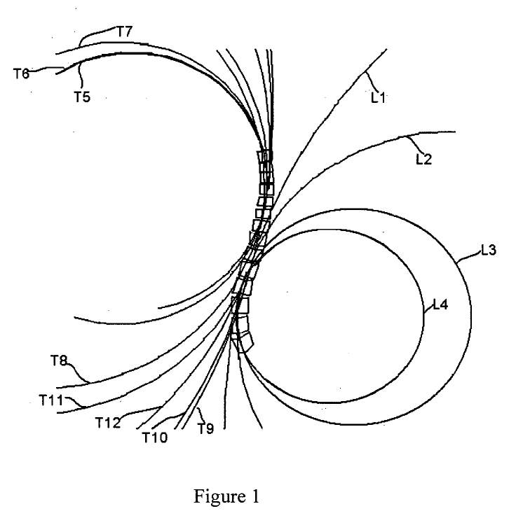

FIG. 1 shows an example of the different curvatures at each vertebra of an unfractured spine;

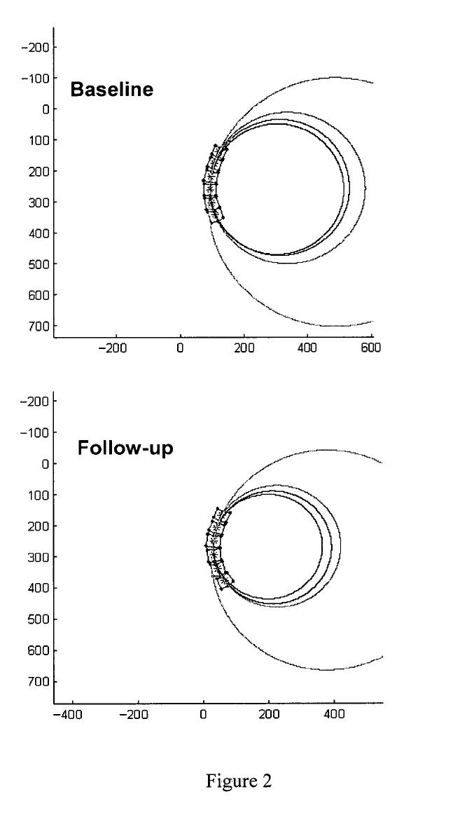

FIG. 2 illustratively provides an example of changes in the degree of lordosis within the same patient over a 5-year period;

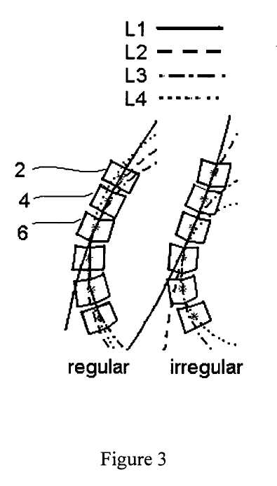

FIG. 3 shows an exemplary view of a spine, indicating the respective positions of different vertebrae;

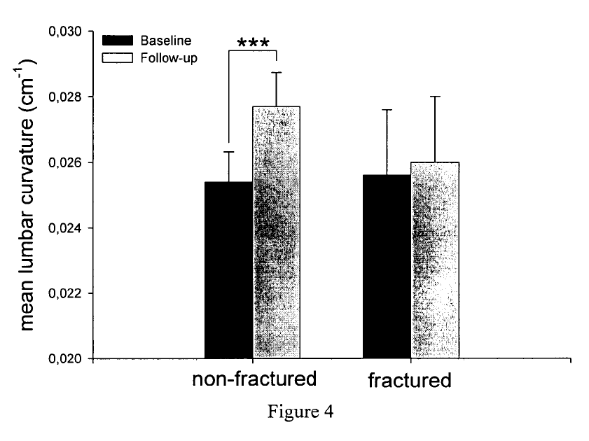

FIG. 4 shows the degree of lumbar lordosis at baseline and at the end of the observation period in patients;

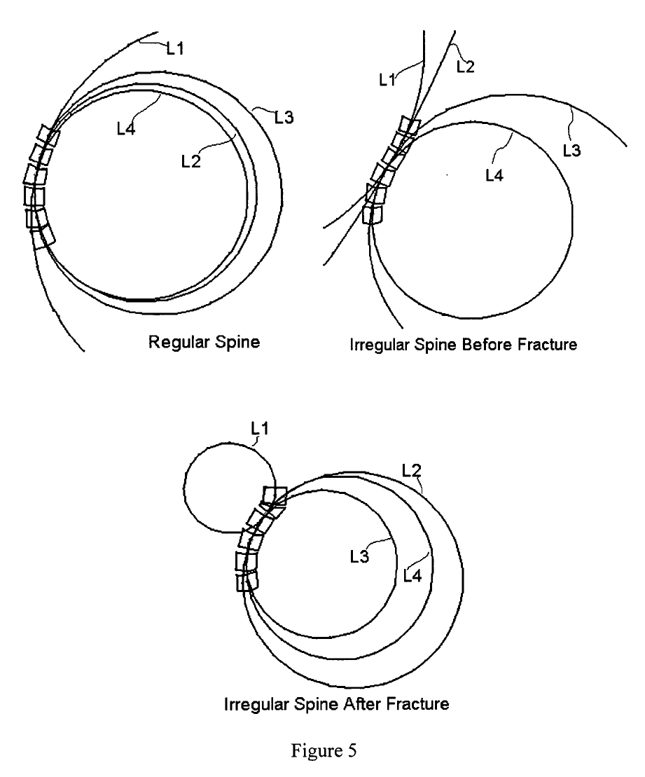

FIG. 5 illustrates the irregularity of vertebral alignment before and after a sustained L1 fracture in the same patient with reference to a regular spine from a healthy spine; and

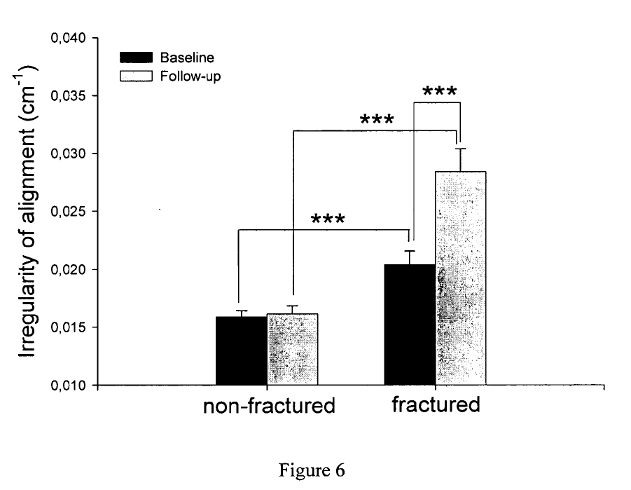

FIG. 6 illustrates the irregularity in patients stratified according to the presence or absence of fractures calculated at baseline and at the end of the observation period.

The present invention will hereinafter be described with particular reference to the analysis of x-ray images of vertebrae of a spine. It will, however, be appreciated that the described method could be applied to other medical images of a spine for example, DXA, Computer Tomography (CT), Ultrasound, or Magnetic Resonance.

A specific embodiment of the invention is described that determines whether computer-based measures of these morphometric parameters can differentiate healthy subjects who later sustain a vertebral fracture from those who maintain vertebral integrity independent of an array of traditional risk factors, including bone mass density (BMD).

The described embodiment focuses on lumbar vertebrae of a spine. However, it will be appreciated that the described method may be applied to other vertebrae of the spine, including thoracic and cervical vertebrae.

The embodiment described is based on a case-control study of 144 postmenopausal women followed for an average of 7.5 years.

The population selected for this analysis was chosen from a prospective epidemiological risk factors (PERF) cohort. To identify patients who had no spinal fracture at baseline but developed at least one lumbar vertebral fracture within a 5 to 8 year period (incident fracture), data was reviewed on 4062 women first screened between 1992 and 1995 and re-examined between 2000 and 2001. In this population, there were a total of 662 patients with at least one new vertebral fracture, of whom 36 had vertebral fracture in the lumbar region only. These subjects were selected and matched with a control group of equal size with comparable age, body mass index (BMI), alcohol and milk consumption, use of hormone replacement treatment, spine BMD (L1-L4), smoking habit, and self-reported physical exercise to establish a case-control setting.

All examinations analysed were performed obeying predefined protocols. At baseline all patients were submitted to x-rays of the thoracic and lumbar spine in the anterior-posterior and lateral projections. Pillows were used when in the lateral position to guarantee good alignment of the vertebral bodies. The focus-film distance was kept constant at 1.2 m and the central beam was directed to T7 when examining the thoracic spine and to L2 when examining the lumbar spine. The patient was asked to hold in expiration for the time acquiring the lumbar radiograph, and to breathe slowly and constantly during the acquisition of the thoracic radiograph. All patients were examined by the same staff.

While anterior-posterior pictures were routinely taken for general view and assessment of vertebral deformities (i.e. scoliosis), fracture assessment was performed on lateral radiographs. All lateral radiographs were digitised and analysed by a specialist in radiology, who classified, re-evaluated and confirmed the presence of fractures according to Genant's semi quantitative method using a minimum 20% difference in the shortest and longest distance between the vertebral end-plates as the criterion for the diagnosis of a vertebral fracture.

For further analysis of the images, the four corner points on each vertebra from TH12 to L5 were marked by the same radiologist using a computer program. The centre-point of each vertebra was defined as the point in the middle between the four corner points, preferably the centre of gravity of the vertebra. Subsequently, local curvature at each vertebra from L1 to L4 was calculated as 1/radius of the circle connecting the centre-point of the given vertebra with the centre points of the neighbouring vertebrae (e.g. the alignment of L1 was described by the curvature of the circle running through the centre-points of Th12, L1 and L2 as shown in the illustrative view of a spine shown in FIG. 1).

The prefix of the curvature measure is taken as positive if the circle is located posterior to the spine and negative if it is located anterior to the spine.

The mean curvature c of individual curves from L1 to L4 quantifies the degree of lordosis (i.e. the physiological curvature of the lumbar spine):

$$c = \frac{1}{4} {\sum }_{i = 1}^{4} \frac{1}{radius {L}_{i}}$$

An example of the circles obtained for different degrees of lordosis is given in FIG. 2. FIG. 2 shows the increased curvature of the lumbar spine and the concomitant decrease in the radius of the individual circles (L1 to L4) from baseline to follow-up. A further illustration is shown in FIG. 3 where the variation between a regular and irregular spine can clearly be seen. The more lordotic the lumbar spine is, the closer the spinous processes are to each other and the larger are the gaps between the anterior parts of the vertebral bodies.

The physiological curvatures of the spine are produced by subtle differences in the anterior and posterior vertebral heights within a vertebra and between adjacent vertebrae. If the degree of bending in adjacent vertebrae is comparable, the curvature of fitted circles will be largely comparable, with a trend toward gradually decreasing radius (or increasing curvatures) of circles from L1 to L4 as seen in FIG. 1. However, when the bending of the spine at a given level changes abruptly, a sudden change in the radius and or position of the circles occurs, thereby revealing the presence of an irregularity. The measure of irregularity tested in this study is defined as the average of absolute differences between the individual curvatures (L1 to L4) and the mean curvature c

$$\frac{1}{4} {\sum }_{i = 1}^{4} abs ( \frac{1}{radius {L}_{i}} - c )$$

FIG. 5 shows an example of marked irregularity in vertebral alignment compared with a control.

Specifically, FIG. 5 shows an example of irregularity of vertebral alignment before and after a sustained L1 fracture in the same patient with reference to a regular spine from a healthy subject. The straightening of the upper lumbar spine compared with the control spine is clear from the increase in the radius and changed position with respect to the spine of L1 and L2 circles compared with those of L3 and L4. The increase in irregularity following a vertebral fracture (in this case in L1) is indicated by the marked decrease in the radius of the L1 and L2 circles, the latter also changing its position with respect to the spine.

The characteristic indication of irregularity is the atypical location and radius of a circle. As shown in FIG. 2, the irregular alignment of L1 is indicated by the L1 circle being located anterior compared with other circles located posterior to the vertebral bodies.

The demographic and skeletal characteristics of the study population are presented below:

| | |
|---|---|
| ‘No fracture’ | ‘Fracture’ |
| group | group |
| (n = 108) | (n = 36) |

| | | | | |
|---|---|---|---|---|
| Age | 65.1 | (7.1) | 64.6 | (7.8) |
| Years since | 16.9 | (8.9) | 17.3 | (10.6) |
| menopause | | | | |
| Height(cm) | 162.1 | (5.9) | 163.0 | (5.47) |
| Weight (kg) | 65.4 | (8.8) | 66.7 | (11.3) |
| BMI, kg/m² | 24.9 | (3.4) | 24.9 | (3.8) |
| Change in weight, | −1.5 | (1.9) | −2.8 | (1.9)* |
| kg | | | | |
| Baseline | 0.845 | (0.127) | 0.834 | (0.148) |
| spine BMD, g/cm² | | | | |
| Delta BMD, % | 0.5 | (6.2) | 5.8 | (8.3)* |
| Distribution of vertebral | | | | |
| fractures | | | | |

| | | |
|---|---|---|
| L1 | 0 | 18 |
| L2 | 0 | 10 |
| L3 | 0 | 4 |
| L4 | 0 | 6 |
| Mild | 0 | 6 |
| Moderate | 0 | 26 |
| Severe | 0 | 6 |
| Ant wedge | 0 | 26 |
| Post wedge | 0 | 1 |
| Concave | 0 | 10 |
| Crush | 0 | 1 |
| Number of fractures | | |
| 1 | 0 | 34 |
| 2 | 0 | 2 |
| 3 | 0 | 0 |
| Non-vertebral | | |
| fractures | | |
| baseline | 6 | 0 |
| new | 2 | 0 |

Mean values of lordosis or irregularity at baseline or follow-up were compared using Student's t-test for unpaired observation. Longitudinal changes of the parameters on an individual basis were tested using Student's t-test for paired observations. Differences were considered statistically significant, if p was below 5%. Data was analysed with SPSS data analysis software.

The demographic and skeletal characteristics of the study population are presented in the table above. The only statistically (though not clinically) significant difference between the two groups was a greater loss of weight in the fracture compared with the control group. Spine BMD showed a somewhat greater increase from baseline in the fracture group, but it is a direct consequence of a more comprised vertebral body increasing density.

At baseline, no significant differences were found in the degree of lordosis between the two groups. When compared over a period of 7.5 years the values of curvature and hence the degree of lordosis has changed significantly in the healthy group, whereas no changes were noted in the group sustaining a fracture during the observation period. The corresponding numerical data for these two groups is shown in FIG. 6.

FIG. 6 shows that the two groups of subjects with or without future vertebral fractures were significantly different in terms of the measure of irregularity in vertebral alignment (p=0.002). Differences were apparent both at baseline and follow-up. In the group sustaining at least one lumbar fracture, the measure of irregularity increased significantly from baseline, whereas no significant changes were seen in those who sustained vertebral integrity during the observation period. Logistic regression including the measure of irregularity together with the selected well established risk factors of vertebral fractures (age, BMI, spine BMD, smoking and physical exercise) as independent variables confirmed the independent predictive value of the morphometric measure (p<0.001).

Based on these tests, it has been shown by the present inventors that:

1) irregularity of vertebral alignment but not the degree of the physiological curvature of the lumbar spine is predictive for vertebral fractures in the same anatomic region;
2) the occurrence of at least one vertebral fracture in the lumbar spine reverses the progressive age-related increase in the degree of lordosis and causes increased irregularity in vertebral alignment;
3) the predictive value of irregularity is independent of spine BMD and traditional risk factors.

Collectively, the findings highlight the independent role of load distribution in fracture development and provide further explanation about why increasing BMD is insufficient for the prevention of subsequent fractures once osteoporosis is manifest.

The degree of lordosis was not significantly different at baseline in women who later sustained a vertebral fracture compared with those who did not. This observation is in line with the notion that the physiological range of vertebral shapes, that has an important role in the determination of spinal curvatures, does not introduce a variation in vertebral load and load distribution sufficient to affect fracture risk.

Based on these theoretical considerations, in a preferred embodiment, and as described above, a local curvature of each lumbar vertebra is defined as the 1/radius of the circle that goes through the centre-point of a particular vertebra and the centre-point of the two neighbouring vertebrae.

Irregularity is expressed as the average of absolute differences between the individual curvatures (L1 to L4) and the mean curvature of the lumbar spine. When testing this parameter in a longitudinal setting, it was found that those who sustained a vertebral fracture in the lumbar spine at the end of the observation period had significantly higher values of irregularity compared with those who maintained structural integrity. In other words, increased irregularities were predictive for future fractures (independent of an array of traditional risk factors, including BMD). This observation thus also suggests that irregular alignment is an independent contributor to the ultimate manifestation of vertebral fractures by rearranging the mechanical load to a given vertebra with consequently enhanced challenge to maintain structural integrity.

Since the measure of irregularity is a continuous variable, it also facilitates the monitoring of changes over time. In the present study, no significant changes of irregularity in the healthy group not sustaining any fractures were found during the observation period. By contrast, irregularity increased significantly in those sustaining at least one fracture in the lumbar spine. This latter observation provides insight into the strong inclinations of women with a prevalent fracture to sustain a second fracture. Thus, severe morphologic deformations of prevalent fractures, in contrast to the quantitative changes of physiologic curvatures (i.e. degree of lordosis) may cause great alterations of mechanical loading increasing the risk of subsequent fracture(s).

In an alternative embodiment, local curvature of each vertebra can be determined by deriving circles that are obtained by fitting the circle that best matches the four corner points of a vertebra and its neighbours. The best match is for instance the circle that minimises the sum of squared distances between the points and the circle curve.

In each of the above described cases, if the vertebrae are aligned in a regular fashion, one would expect them to lie on approximately the same circle, resulting in equal local curvature values for each vertebra. The average of absolute differences between the individual curvatures and the mean curvature thus defines a measure of irregularity of vertebral alignment.

Alternatively, instead of analysing the curvature by approximating circles through subsequent vertebrae, one can measure the angles between the dominant orientations of subsequent vertebrae. For instance, the angle between the line segments connecting a vertebra with its predecessor and successor. The angle between the superior or inferior endplates of subsequent vertebrae can be calculated, as can the angle between the lines connecting the midpoints of the superior and inferior endplates of a vertebra, or the angle between the lines in the middle between the superior and inferior endplates.

Other methods for determining irregularity include a measurement of:

1) the variance in measured curvature values;
2) the standard deviation in measured curvature values;
3) each of the above measures but for angles instead of curvature values;
4) each of the above measures again for curvature radius;
5) each of the above measures for the logarithm or any function of the measured curvature values, angles, or curvature radii;
6) the logarithm or any function of each of the above measures;
7) the mean distances to circles corresponding to other vertebrae in the same range.

The measure of irregularity described in Zebaze et al may be used in this invention also.

To derive a value for more global curvature (i.e. throughout the range of vertebrae) one could find the circle that best fits a range of vertebrae, for instance all lumbar vertebrae, where the vertebrae can be defined by their centre points, by their four corner points, by the four corner points plus two mid points of the superior and inferior endplates as are used in quantitative fracture grading, or by the full contour. The goodness-of-fit (for instance sum of squared distances) defines the (ir)regularity of the spine.

In this specification, unless expressly otherwise indicated, the word ‘or’ is used in the sense of an operator that returns a true value when either or both of the stated conditions is met, as opposed to the operator ‘exclusive or’ which requires that only one of the conditions is met. The word ‘comprising’ is used in the sense of ‘including’ rather than in to mean ‘consisting of’.

1. A method of estimating the risk of a future fracture in vertebrae of a spine by processing data derived from an image of at least part of a spine, comprising the steps of, in a computer:
processing position data relating to at least four neighbouring vertebrae of the spine;
calculating the curvature of the spine at least two of said neighbouring vertebrae;
computing the different curvature values to obtain a value representative of the degree of irregularity in curvature of the spine, and using the degree of irregularity in curvature of the spine to provide an estimate of the risk of a future fracture in vertebrae of the spine, a higher degree of irregularity indicating a higher risk of future fracture.

2. A method as claimed in claim 1, further comprising:
processing position data derived from a later image of the same part of said spine and relating to the same at least four neighbouring vertebrae of the spine for which data was used previously;
calculating the curvature of the spine at the same at least two of said neighbouring vertebrae for which curvature was calculated previously;
computing the different new curvature values to obtain a new value representative of the degree of irregularity in curvature of the spine; and
comparing the new value representative of the degree of irregularity in curvature of the spine with the value obtained earlier in time.

3. A method as claimed in claim 1, further comprising:
processing position data relating to n neighbouring vertebrae in a region of interest of the spine;
calculating the curvature of the spine at n−2 of the n neighbouring vertebrae; and
using the curvature values at said n−2 vertebrae vertebra, calculating the mean curvature of the region of interest of the spine.

4. A method as claimed in claim 3, wherein the step of deriving a value representative of the irregularity of curvature of the spine comprises calculating a value representing an average of the absolute differences between individual curvatures at 2 to n−2 vertebrae in the region of interest of the spine and the mean curvature of the region of interest of the spine.

5. A method as claimed in claim 1, wherein the step of calculating the curvature at the individual vertebrae comprises:
identifying a corresponding feature in three adjacent vertebrae of said at least four neighbouring vertebrae; and
using said corresponding features to calculate curvature of the spine at the middle vertebra of said three adjacent vertebrae.

6. A method as claimed in claim 5, wherein the step of identifying a corresponding feature in each of said three adjacent vertebrae comprises locating the centre point of each vertebra, the method further comprising:
using the centre points of said three adjacent vertebrae to define part of a circle; and
calculating the radius of said circle, wherein a value representative of curvature is calculated as the inverse of the radius.

7. A method as claimed in claim 1, wherein the step of identifying a corresponding feature in each of said three adjacent vertebrae comprises locating the corner points of each vertebra, the method further comprising:
using said corner points of said three adjacent vertebrae to define part of a circle; and
calculating the radius of said circle, wherein a value representative of curvature is calculated as the inverse of the radius.

8. A method as claimed in claim 1, wherein the step of calculating the curvature at the individual vertebrae comprises:
calculating the angle of orientation of one vertebra relative to its two adjacent vertebrae.

9. An instruction set comprising instructions for in a computer:
processing position data relating to at least four neighbouring vertebrae of the spine;
calculating the curvature of the spine at least two of said neighbouring vertebrae;
computing the different curvature values to obtain a value representative of the degree of irregularity in curvature of the spine, and using the degree of irregularity in curvature of the spine to provide an estimate of the risk of a future fracture in vertebrae of the spine, a higher degree of irregularity indicating a higher risk of future fracture.

10. An instruction set as claimed in claim 9, further comprising instructions for:
processing position data derived from a later image of the same part of said spine and relating to the same at least four neighbouring vertebrae of the spine for which data was used previously;
calculating the curvature of the spine at the same at least two of said neighbouring vertebrae for which curvature was calculated previously;
computing the different new curvature values to obtain a new value representative of the degree of irregularity in curvature of the spine; and
comparing the new value representative of the degree of irregularity in curvature of the spine with the value obtained earlier in time.

11. An instruction set as claimed in claim 9, further comprising instructions for:
processing position data relating to n neighbouring vertebrae in a region of interest of the spine;
calculating the curvature of the spine at n−2 of the n neighbouring vertebrae; and
using the curvature values at said n−2 vertebrae vertebra, calculating the mean curvature of the region of interest of the spine.

12. An instruction set as claimed in claim 11, wherein the instructions for deriving a value representative of the irregularity of curvature of the spine further comprise instructions for calculating a value representing an average of the absolute differences between individual curvatures at 2 to n−2 vertebrae in the region of interest of the spine and the mean curvature of the region of interest of the spine.

13-15. (canceled)

16. An instruction set as claimed in claim 9, wherein the instructions for calculating the curvature at the individual vertebrae comprises further instructions for:
calculating the angle of orientation of one vertebra relative to its two adjacent vertebrae.

17. A data storage and processing apparatus for estimating the risk of a future fracture in vertebrae of a spine by processing an image of part of a spine, the data storage and processing apparatus comprising a processor arranged to:
process position data relating to at least four neighbouring vertebrae of the spine;
calculate the curvature of the spine at least two of said neighbouring vertebrae;
compute the different curvature values to obtain a value representative of the degree of irregularity in curvature of the spine, and using the degree of irregularity in curvature of the spine to provide an estimate of the risk of a future fracture in vertebrae of the spine, a higher degree of irregularity indicating a higher risk of future fracture.

18. A data storage and processing apparatus as claimed in claim 17, wherein the processor is further arranged to:
process position data derived from a later image of the same part of said spine and relating to the same at least four neighbouring vertebrae of the spine for which data was used previously;
calculate the curvature of the spine at the same at least two of said neighbouring vertebrae for which curvature was calculated previously;
compute the different curvature values to obtain a value representative of the degree of irregularity in curvature of the spine; and
compare the degree of irregularity in curvature of the spine with the value obtained earlier in time.

19. A data storage and processing apparatus as claimed in claim 17, wherein the processor is further arranged to:
process position data relating to n neighbouring vertebrae in a region of interest of the spine;
calculate the curvature of the spine at n−2 of the n neighbouring vertebrae; and
using the curvature values at said n−2 vertebrae vertebra, calculate the mean curvature of the region of interest of the spine.

20. A data storage and processing apparatus as claimed in claim 19, wherein the processor is further arranged to calculate a value representing an average of the absolute differences between individual curvatures at 2 to n−2 vertebrae in the region of interest of the spine and the mean curvature of the region of interest of the spine when deriving a value representative of the irregularity of curvature of the spine.

21-24. (canceled)
